(19) United States
(12) Patent Application Publication
(10) Pub. No.: US 2008/0053764 A1
(43) Pub. Date: Mar. 6, 2008

(54) Front fork

(75) Inventors: Takao Tomonaga, Iwata-shi (JP); Yosuke Murakami, Fukuroi-shi (JP); Daiki Takehana, Fukuroi-shi (JP)

Correspondence Address: OSHA LIANG L.L.P., 1221 MCKINNEY STREET, SUITE 2800, HOUSTON, TX, 77010, US

(73) Assignee: Showa Corporation, Gyoda-Shi (JP)

(21) Appl. No.: 11/724,830

(22) Filed: Mar. 15, 2007

(30) Foreign Application Priority Data
Aug. 29, 2006 (JP) 2006-232829

(51) Int. Cl. F16F 9/18

(52) U.S. Cl. 188/315

(57) ABSTRACT

A front fork including an axle side tube, an axle bracket connected to the axle side tube, and a damper cylinder is disclosed. A lower end of the damper cylinder is held between the axle bracket and a lower end of the axle side tube. Furthermore, a damping force generating apparatus is provided in the axle bracket, and an inner portion and an outer portion of the damper cylinder are communicated via the damping force generating apparatus.

### BACKGROUND OF THE INVENTION

1. Field of the Invention

The present invention relates to a front fork.

2. Description of the Related Art

A front fork, as described in Japanese Patent Utility Model Application Laid-open No. 2-138246 (hereinafter “patent document 1”), typically includes a structure in which an axle side tube is screwed to an axle tube, a lower end of a damper cylinder is held between an axis bracket and a lower end of the axis side tube, and a damping force generating apparatus (a base valve portion) is accommodated in an inner portion at a lower end side of the damper cylinder.

In the front fork described in patent document 1, because the damping force generating apparatus is accommodated in the inner portion of the damper cylinder, it is necessary to change a setting of a damping characteristic of the damping force generating apparatus (e.g., a sheet number, a thickness, etc., of a leaf valve) by disassembling the front fork so as to detach the damper cylinder from the axle bracket. Those skilled in the art will recognize that this is a cumbersome and difficult task.

### SUMMARY OF THE INVENTION

An object of the present invention is to easily switch a setting of a damping characteristic of a damping force generating apparatus, as well as shortening a length in an axial direction of a damper cylinder, in a front fork.

In one aspect, the invention relates to a front fork including an axle side tube, an axle bracket connected to the axle side tube, and a damper cylinder, wherein a lower end of the damper cylinder is held between the axle bracket and a lower end of the axle side tube, wherein a damping force generating apparatus is provided in the axle bracket, and an inner portion and an outer portion of the damper cylinder are communicated via the damping force generating apparatus.

Other aspects of the invention will be apparent from the following description and the appended claims.

### BRIEF DESCRIPTION OF THE DRAWINGS

The present invention will be more fully understood from the detailed description given below and from the accompanying drawings which should not be taken to be a limitation on the invention, but are for explanation and understanding only.

The drawings:

FIG. 1 is a cross sectional view of a front fork in accordance with an embodiment of the present invention;

FIG. 2 is an enlarged cross sectional view of a lower portion of the front fork in FIG. 1;

FIG. 3 is an enlarged cross sectional view of a middle portion of the front fork in FIG. 1;

FIG. 4 is an enlarged cross sectional view of an upper portion of the front fork in FIG. 1; and

FIG. 5 is a cross sectional view showing a damping force generating apparatus provided in an axle bracket in accordance with an embodiment of the present invention.

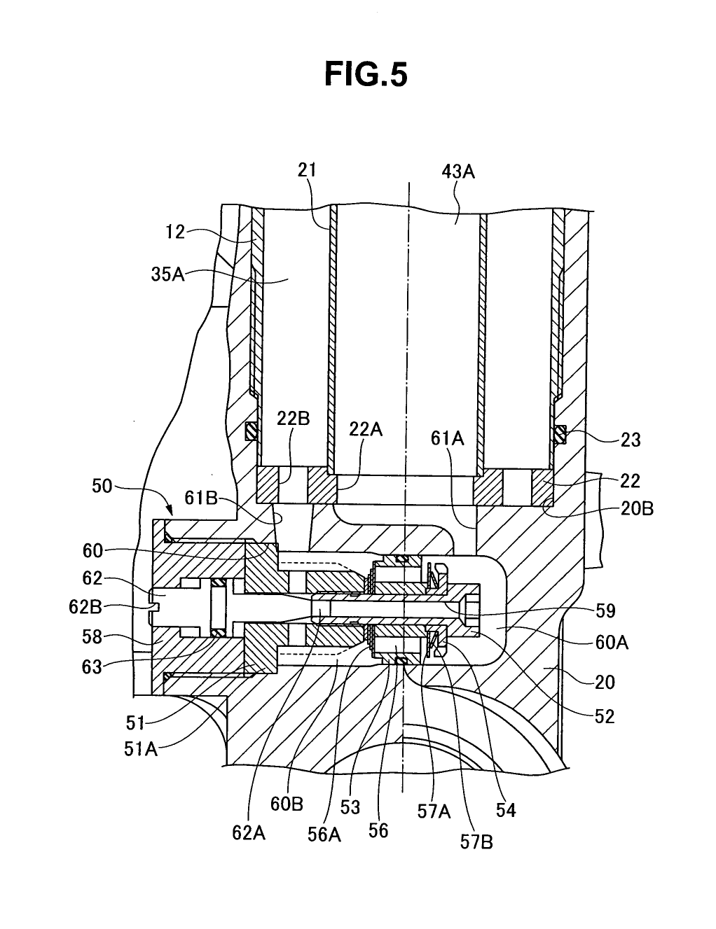

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

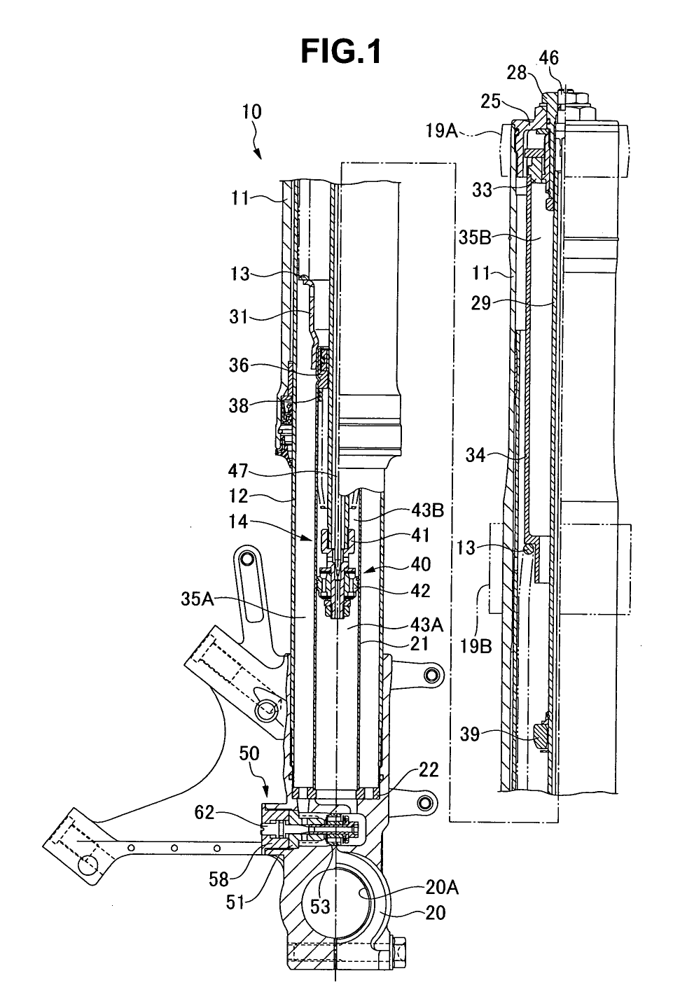

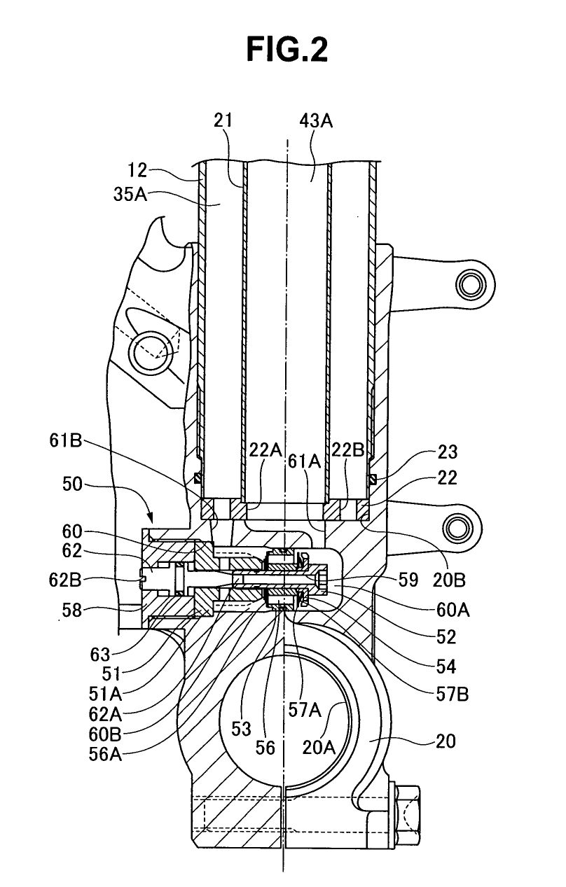

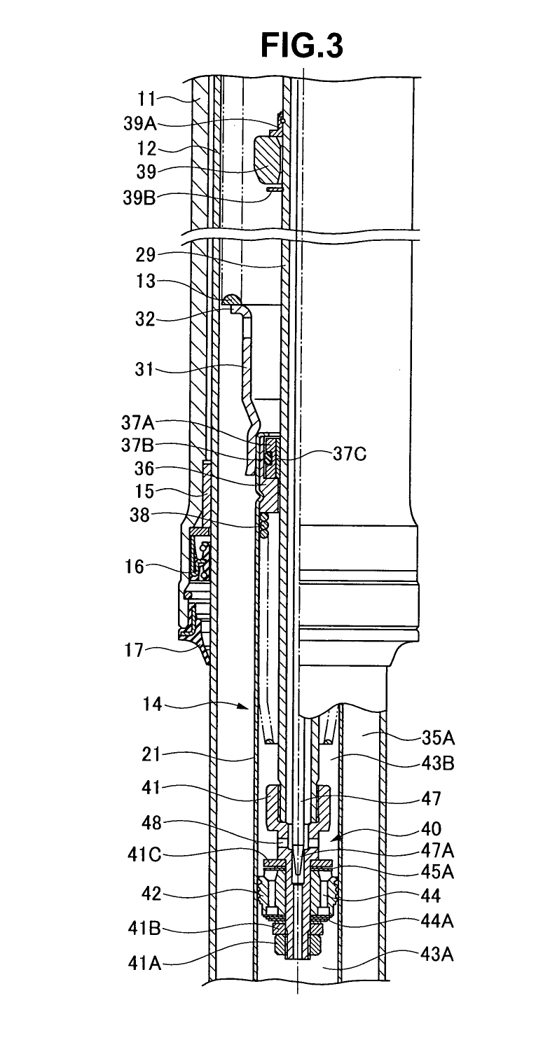

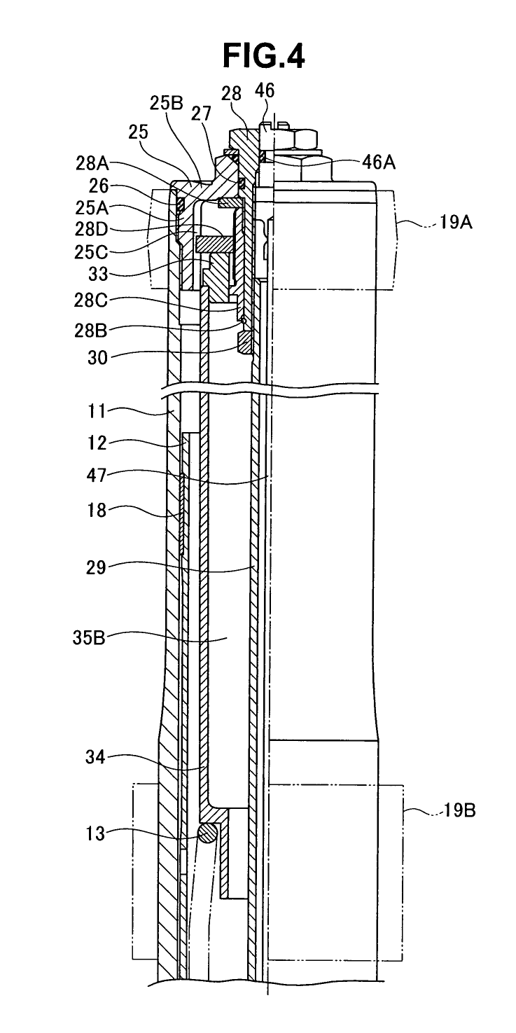

A front fork 10 is structured, as shown in FIGS. 1 to 4, such that an outer tube (a vehicle body side tube) 11 at a vehicle body side is slidably fitted to an inner tube (an axle side tube) 12 at an axle side so as to be inverted. Furthermore, a suspension spring 13 is interposed disposed within both the tubes 11 and 12, and, further, a single pipe type damper 14 is disposed therein in an erect manner.

A bush 15, an oil seal 16, and a dust seal 17, with which an outer peripheral portion of the inner tube 12 is brought into slidable contact, are fitted and attached to an inner peripheral portion of a lower end of the outer tube 11. A bush 18, with which an inner peripheral portion of the outer tube 11 is brought into slidable contact, is fitted and attached to an outer peripheral portion of an upper end of the inner tube 12.

The outer tube 11 is connected to a vehicle body side via an upper bracket 19A and a lower bracket 19B, and the inner tube 12 is inserted and attached in a liquid tight manner to an axle bracket 20 via an O-ring 23, and, further, is coupled to an axle via an axle hole 20A of the axle bracket 20.

A lower end of a damper cylinder 21 of the damper 14 is held between the axle bracket 20 and a lower end of the inner tube 12. In other words, a center step hole of a bottom plate 22 is fitted and attached to a lower end of the damper cylinder 21, a step hole periphery of the bottom plate 22 is welded to an outer periphery of the lower end of the damper cylinder 21, and an outer peripheral portion of the bottom plate 22 is fitted to a fitting hole 20B of the axle bracket 20, and is held between the axle bracket 20 and the lower end of the inner tube 12. The bottom plate 22 is provided with a center hole 22A communicating with a piston side oil chamber 43A mentioned below, and a plurality of small holes 22B communicating with an oil reservoir chamber 35A mentioned below.

A cylinder portion 25A of a cap 25 is inserted and attached in a liquid tight manner to the upper end portion of the outer tube 11 via an O-ring 26 so as to be screwed, and a spring load adjuster 28 is rotatably inserted in a liquid tight manner to an inner periphery of a lid portion 25B of the cap 25 via an O-ring 27. A base end portion of a piston rod 29 is screwed to an inner periphery of a lower end of the spring load adjuster 28, and is locked by a lock nut 30. A leading end portion of the piston rod 29 is inserted into the damper cylinder 21.

An oil lock collar 31 is fixed to an outer peripheral portion of the upper end of the damper cylinder 21 in the inner portion of the inner tube 12, and a spring bearing 32 is provided at an upper end portion of the oil lock collar 31.

Furthermore, a collar 28A mated with a lower surface at an inner side of the lid portion 25B of the cap 25 is inserted and attached to an outer periphery at an upper end side of the spring load adjuster 28 in the inner portion of the outer tube 11. Additionally, a stop ring 28B is locked and attached to an outer periphery of the lower end side of the spring load adjuster 28, and a thread tube 28C vertically held by the collar 28A and the stop ring 28B is screwed and fixed to an outer periphery of the spring load adjuster 28, and is integrally rotated therewith. An adjust plate 28D screwed to a thread tube 28C of the spring load adjuster 28 is prevented from rotating with respect to a groove portion 25C of the cap 25, engages with an upper end of the suspension spring 13 via a slider 33 and a spring collar 34, and engages with a lower end of the suspension spring 13 by a spring bearing 32. The adjust plate 28D is moved up and down by rotationally operating the spring load adjuster 28, and an initial load of the suspension spring 13 may be set via the spring collar 34.

An oil reservoir chamber 35A and a gas chamber 35B are provided in the inner portion of the outer tube 11 and the inner tube 12, and in the outer peripheral portion of the damper cylinder 21. Furthermore, a gas sealed in the gas chamber 35B constitutes a gas spring. A working fluid in the oil reservoir chamber 35A contributes to an adjustment of a spring constant of the gas chamber 35B, a lubrication of the slidable contact bushes 15 and 18 of the outer tube 11 and the inner tube 12, and a lubrication of the oil seal 16 in the lower end portion of the inner tube 12. Further, spring forces of the suspension spring 13 and the gas spring absorb an impact force to which the vehicle is applied from a road surface.

The damper 14 has a piston valve apparatus (an extension side damping force generating apparatus) 40 and a bottom valve apparatus (a compression side damping force generating apparatus) 50. The damper 14 suppresses a stretching vibration of the outer tube 11 and the inner tube 12 in correspondence to the absorption of the impact force generated by the suspension spring 13 and the gas spring on the basis of the damping forces generated by the piston valve apparatus 40 and the bottom valve apparatus 50.

A rod guide 36 is caulked and fixed to an upper end opening portion of the damper cylinder 21, and a bush housing 37A is attached to the rod guide 36 via an O-ring 37B so as to be fixed, and guides the piston rod 29 in a slidable contact manner by a bush 37C pressure inserted into the bush housing 37A.

In this case, a rebound spring 38 is held just below the rod guide 36 in the inner periphery of the damper cylinder 21. The rebound spring 38 is compressed with respect to a piston holder 41 mentioned below at a time of being extended to a maximum so as to serve as a cushioning operation.

Further, an oil lock piece 39 held by upper and lower holders 39A and 39B is held at the outer periphery of the piston rod 29 so as to have a gap at the outer periphery with respect to the piston rod 29. Further, it may possible to achieve the cushioning operation at a time of being compressed to a maximum by moving forward the oil lock piece 39 to the oil lock collar 31 mentioned above.

A description will be given below of the damping mechanism of the front fork 10 in accordance with one or more embodiments of the present invention.

(Piston Valve Apparatus 40)

The piston valve apparatus 40 is structured such that the piston holder 41 is installed to a leading end portion of the piston rod 29, and a piston 42 and a valve stopper 41C are installed by a nut 41A screwed to the piston holder 41 and a valve stopper 41B. The piston 42 is brought into slidable contact with the inner portion of the damper cylinder 21, and comparts the inner portion of the damper cylinder 21 into a piston side oil chamber 43A in which the piston rod 29 is not accommodated, and a rod side oil chamber 43B in which the piston rod 29 is accommodated. The piston 42 is provided with an extension side flow path 44 provided with an extension side valve 44A so as to be capable of communicating the piston side oil chamber 43A with the rod side oil chamber 43B, and a compression side flow path 45 (not shown) provided with a compression side valve (a check valve) 45A so as to be capable of communicating the piston side oil chamber 43A with the rod side oil chamber 43B.

Further, the piston valve apparatus 40 includes a damping force adjusting rod 47 fixed by caulking to a damping force adjuster 46, which is inserted and attached in a liquid tight manner to the spring load adjuster 28 via an O-ring 46A and is screwed thereto so as to be operable from an external portion. The damping force adjusting rod 47 is inserted through a hollow portion of the piston rod 29, and can adjust a flow path area of a bypass path 48 of the piston side oil chamber 43A and the rod side oil chamber 43B, provided in the piston holder 41, by a needle 47A in a leading end of the damping force adjusting rod 47.

Accordingly, at a time when the front fork 10 is compressed, the oil in the piston side oil chamber 43A passes through the compression side flow path 45, opens the compression side valve 45A, and is introduced to the rod side oil chamber 43B.

Further, at a time when the front fork 10 is extended, the oil in the rod side oil chamber 43B is introduced to the piston side oil chamber 43A through the bypass path 48 in which the needle 47A is disposed, in the case that a relative speed of the damper cylinder 21 and the piston rod 29 is low, and an extension side damping force is generated on the basis of a throttle resistance by the needle 47A therebetween. The damping force is adjusted by adjusting a position of the needle 47A by means of the damping force adjuster 46.

Further, at a time when the front fork 10 is extended, and the relative speed of the damper cylinder 21 and the piston rod 29 is moderate or high, the oil in the rod side oil chamber 43B passes through the extension side flow path 44, deflects the extension side valve 44A, and is introduced to the piston side oil chamber 43A, and the extension side damping force is generated.

(Bottom Valve Apparatus 50)

The bottom valve apparatus 50 includes a bottom piece 51 inserted in a bottom valve hole 60 pierced in a center axis of the axle bracket 20, the bottom valve hole 60 being orthogonal to the axle hole 20A of the axle bracket 20 from a lateral direction. The bottom valve apparatus 50 further includes a flange 51A of the bottom piece 51 fixed to the axle bracket 20 by a cap 58 screwed to a sideways opening portion of the bottom valve hole 60. The bottom valve apparatus 50 holds a compression side valve 56A formed by laminating a plurality of sheet valves, a valve housing 53, and a valve stopper 54 to the bottom piece 51 by a bolt 52. The valve stopper 54 holds an extension side valve (a check valve) 57A and a spring 57B with respect to the valve housing 53. The valve housing 53 is fitted in a liquid tight manner to an intermediate portion of the bottom valve hole 60 provided in the axle bracket 20, and comparts a first bottom valve chamber 60A and a second bottom valve chamber 60B. The first bottom valve chamber 60A is communicated with the piston side oil chamber 43A via a first communication hole 61A provided in the axle bracket 20 and the center hole 22A of the bottom plate 22. The second bottom valve chamber 60B is communicated with the oil reservoir chamber 35A via the second communication hole 61B provided in the axle bracket 20 and the small hole 22B of the bottom plate 22. The valve housing 53 is provided with a compression side flow path 56 having a compression side valve 56A so as to be capable of communicating the first bottom valve chamber 60A with the second bottom valve chamber 60B. The valve housing 53 is further provided with an extension side flow path 57 (not shown) having an extension side valve 57A so as to be capable of communicating the first bottom valve chamber 60A with the second bottom valve chamber 60B. Accordingly, the piston side oil chamber 43A in the inner portion of the damper cylinder 21 is communicated with the oil reservoir chamber 35A in the outer portion of the damper cylinder 21 via the flow paths 56 and 57 of the bottom valve apparatus 50.

The bottom valve apparatus 50 is provided with a bypass flow path 59 which can communicate the first bottom valve chamber 60A and the second bottom valve chamber 60B, and, thus, the piston side oil chamber 43A and the oil reservoir chamber 35A, while bypassing the compression side flow path 56 and the extension side flow path 57, in the bottom piece 51 and the bolt 52. Further, a damping force adjusting rod 62 is inserted and attached in a liquid tight manner onto the center axis of the cap 58 screwed to the axle bracket 20 via an O-ring 63. Furthermore, a leading end needle 62A of the damping force adjusting rod 62 is inserted into the bypass flow path 59 of the bottom piece 51 and the bolt 52. A base end operation portion 62B of the damping force adjusting rod 62 is arranged at a position facing an outer side at an end surface of the cap 58 screwed to the sideways opening portion of the bottom valve hole 60 while avoiding the axle hole 20A of the axle bracket 20, moves the needle 62A forward and backward by moving the damping force adjusting rod 62 to the bottom piece 51, and can adjust a flow path area of the needle 62A.

Accordingly, at a time when the front fork 10 is compressed, the oil at a volumetric capacity generated by the piston rod 29 going into the damper cylinder 21 is discharged to the oil reservoir chamber 35A from the piston side oil chamber 43A through the bypass flow path 59 or through the compression side flow path 56. At this time, in the case that the relative speed of the damper cylinder 21 and the piston rod 29 is low, it is possible to obtain the compression side damping force on the basis of a throttle resistance generated by the needle 62A provided in the bypass flow path 59. The damping force is adjusted by adjusting the position of the needle 62A by means of the operating portion 62B of the damping force adjusting rod 62. Further, in the case that the relative speed of the damper cylinder 21 and the piston rod 29 is moderate or high, the oil passing through the compression side flow path 56 from the piston side oil chamber 43A deflects the compression side valve 56A so as to generate the compression side damping force.

At a time when the front fork 10 is extended, the oil at a volumetric capacity of the piston rod 29 going out of the damper cylinder 21 flows back to the piston side oil chamber 43A from the oil reservoir chamber 35A through the extension side flow path 57.

Accordingly, in one or more embodiments of the present invention, the front fork 10 executes the damping operation as mentioned below.

(Compression Time)

At a time when the front fork 10 is compressed, in the bottom valve apparatus 50, the compression side damping force is generated by the oil flowing through the compression side valve 56A of the valve housing 53 or the needle 62A, and the damping force may be generated to a lesser extent in the piston valve apparatus 40.

(Extension Time)

At a time when the front fork 10 is extended, in the piston valve apparatus 40, the extension side damping force is generated by the oil flowing through the needle 47A of the piston 42 or the extension side valve 44A, and the damping force may be generated to a lesser extent in the bottom valve apparatus 50.

The stretching vibration of the front fork 10 may be suppressed by the damping forces in the compression side and the extension side.

In accordance with the present embodiment, it may be possible to achieve the following operations and effects.

(a) Because the bottom valve apparatus 50 is provided in the axle bracket 20, it may be possible to more easily change a setting of a damping characteristic of the bottom valve apparatus 50 (e.g., the number, the thickness, etc., of the sheet valve) without disassembling the front fork 10 so as to take out the damper cylinder 21.

(b) Because the bottom valve apparatus 50 is provided in the axle bracket 20, it may be less difficult to set the damping force adjusting rod 62 in the bottom valve apparatus 50, and to arrange the operation portion 62B of the damping force adjusting rod 62 at a position avoiding the axle hole of the axle bracket 20.

(c) Because the bottom valve apparatus 50 is provided in the axle bracket 20, it is not necessary to set the bottom valve apparatus 50 in the inner portion of the damper cylinder 21, and it may be possible to easily weld the bottom plate 22 to the lower end of the damper cylinder 21. In comparison with the structure in which the bottom plate 22 is attached by caulking to the lower end of the damper cylinder 21, or the collar-shaped portion in place of the bottom plate 22 is provided by expanding the lower end of the damper cylinder 21, it may be possible to hold the bottom plate 22, firmly coupled to the damper cylinder 21, between the axle bracket 20 and the lower end of the inner tube 12. Further, it may be possible to improve a tensile strength of the front fork 10.

(d) It may be possible to simplify an attaching and fixing structure and limit a cost without necessity of the bottom bolt 24 for attaching the damper cylinder 21 of the damper 14 to the bottom portion of the inner tube 12, or fixing the bottom piece 51 of the bottom valve apparatus 50.

As heretofore explained, embodiments of the present invention have been described in detail with reference to the drawings. However, the specific configurations of the present invention are not limited to the illustrated embodiments. Accordingly, those embodiments having a modification of the design within the range of the presently claimed invention are also included in the present invention.

Although the invention has been illustrated and described with respect to several exemplary embodiments thereof, it should be understood by those skilled in the art that the foregoing and various other changes, omissions, and additions may be made to the present invention without departing from the spirit and scope thereof. Therefore, the present invention should not be understood as limited to the specific embodiments set out above, but should be understood to include all possible embodiments which can be encompassed within a scope of equivalents thereof with respect to the features set out in the appended claims.

What is claimed is:

1. A front fork, comprising an axle side tube, an axle bracket connected to the axle side tube, and a damper cylinder, wherein a lower end of the damper cylinder is held between the axle bracket and a lower end of the axle side tube,
wherein a damping force generating apparatus is provided in the axle bracket, and an inner portion and an outer portion of the damper cylinder are communicated via the damping force generating apparatus.

2. The front fork as claimed in claim 1, wherein a damping force adjusting portion is provided in the damping force generating apparatus, and an operation portion of the damping force adjusting portion is arranged at a position avoiding an axle hole of the axle bracket.

3. The front fork as claimed in claim 1, wherein a bottom plate is welded to the lower end of the damper cylinder, and the bottom plate is held between the axle bracket and the lower end of the axle side tube.

4. The front fork as claimed in claim 2, wherein a bottom plate is welded to the lower end of the damper cylinder, and the bottom plate is held between the axle bracket and the lower end of the axle side tube.

5. The front fork as claimed in claim 1, wherein a vehicle body side tube is slidably fitted to the axle side tube, and a piston rod inserted into the damper cylinder is connected to an upper end portion of the vehicle body side tube.

6. The front fork as claimed in claim 2, wherein a vehicle body side tube is slidably fitted to the axle side tube, and a piston rod inserted into the damper cylinder is connected to an upper end portion of the vehicle body side tube.

7. The front fork as claimed in claim 3, wherein a vehicle body side tube is slidably fitted to the axle side tube, and a piston rod inserted into the damper cylinder is connected to an upper end portion of the vehicle body side tube.

8. The front fork as claimed in claim 4, wherein a vehicle body side tube is slidably fitted to the axle side tube, and a piston rod inserted into the damper cylinder is connected to an upper end portion of the vehicle body side tube.

9. The front fork as claimed in claim 3, wherein the axle bracket has a fitting hole of the axle side tube,
wherein the bottom plate has a center step hole, the center step hole of the bottom plate is fitted to a lower end of the damper cylinder, and a portion around the step hole of the bottom plate is welded to an outer periphery of the lower end of the damper cylinder, and
wherein an outer peripheral portion of the bottom plate is fitted to the fitting hole of the axle bracket.

10. The front fork as claimed in claim 4, wherein the axle bracket has a fitting hole of the axle side tube,
wherein the bottom plate has a center step hole, the center step hole of the bottom plate is fitted to a lower end of the damper cylinder, and a portion around the step hole of the bottom plate is welded to an outer periphery of the lower end of the damper cylinder, and
wherein an outer peripheral portion of the bottom plate is fitted to the fitting hole of the axle bracket.

11. The front fork as claimed in claim 5, wherein an oil lock collar is fixed to an outer peripheral portion of an upper end of the damper cylinder, an oil lock piece is held at an outer periphery of the piston rod so as to have a gap at an outer periphery with respect to the piston rod, and the oil lock piece moves into the oil lock collar at a time of being compressed to the maximum.

12. The front fork as claimed in claim 6, wherein an oil lock collar is fixed to an outer peripheral portion of an upper end of the damper cylinder, an oil lock piece is held at an outer periphery of the piston rod so as to have a gap at an outer periphery with respect to the piston rod, and the oil lock piece moves into the oil lock collar at a time of being compressed to the maximum.

13. The front fork as claimed in claim 7, wherein an oil lock collar is fixed to an outer peripheral portion of an upper end of the damper cylinder, an oil lock piece is held at an outer periphery of the piston rod so as to have a gap at an outer periphery with respect to the piston rod, and the oil lock piece moves into the oil lock collar at a time of being compressed to the maximum.

14. The front fork as claimed in claim 8, wherein an oil lock collar is fixed to an outer peripheral portion of an upper end of the damper cylinder, an oil lock piece is held at an outer periphery of the piston rod so as to have a gap at an outer periphery with respect to the piston rod, and the oil lock piece moves into the oil lock collar at a time of being compressed to the maximum.

15. The front fork as claimed in claim 5, wherein a piston is installed to a leading end portion of the piston rod, and the piston is slidably in contact with an inner portion of the damper cylinder,
wherein an oil reservoir chamber and a gas chamber are provided in an outer peripheral portion of the damper cylinder, in inner portions of the vehicle body side tube and the axle side tube, and
wherein the bottom plate has a center hole communicating with a piston side chamber in which the piston rod is not accommodated, in the inner portion of the damper cylinder, and a plurality of small holes communicating with the oil reservoir chamber.

16. The front fork as claimed in claim 6, wherein a piston is installed to a leading end portion of the piston rod, and the piston is slidably in contact with an inner portion of the damper cylinder,
wherein an oil reservoir chamber and a gas chamber are provided in an outer peripheral portion of the damper cylinder, in inner portions of the vehicle body side tube and the axle side tube, and
wherein the bottom plate has a center hole communicating with a piston side chamber in which the piston rod is not accommodated, in the inner portion of the damper cylinder, and a plurality of small holes communicating with the oil reservoir chamber.

17. The front fork as claimed in claim 7, wherein a piston is installed to a leading end portion of the piston rod, and the piston is slidably in contact with an inner portion of the damper cylinder,
wherein an oil reservoir chamber and a gas chamber are provided in an outer peripheral portion of the damper cylinder, in inner portions of the vehicle body side tube and the axle side tube, and
wherein the bottom plate has a center hole communicating with a piston side chamber in which the piston rod is not accommodated, in the inner portion of the damper cylinder, and a plurality of small holes communicating with the oil reservoir chamber.

18. The front fork as claimed in claim 8, wherein a piston is installed to a leading end portion of the piston rod, and the piston is slidably in contact with an inner portion of the damper cylinder,
wherein an oil reservoir chamber and a gas chamber are provided in an outer peripheral portion of the damper cylinder, in inner portions of the vehicle body side tube and the axle side tube, and
wherein the bottom plate has a center hole communicating with a piston side chamber in which the piston rod is not accommodated, in the inner portion of the damper cylinder, and a plurality of small holes communicating with the oil reservoir chamber.

19. The front fork as claimed in claim 2, wherein the damping force generating apparatus is structured such that a bottom piece is inserted into a bottom valve hole pierced to an axis of the axle bracket which is orthogonal to the axle hole of the axle bracket, from a lateral direction, and a flange of the bottom piece is fixed to the axle bracket by a cap screwed to a sideways opening portion of the bottom valve hole.
